(19) United States
(12) Patent Application Publication
(10) Pub. No.: US 2026/0250999 A1
(43) Pub. Date: Aug. 27, 2026

(54) OUTWARD-OPENING MECHANISM FOR WINDOW AND WINDOW

(71) Applicant: SMART HOME (BEIJING) CONSTRUCTION TECHNOLOGY CO., LTD., Beljing (CN)

(72) Inventor: Hailiang LI, Beijing (CN)

(21) Appl. No.: 19/200,825

(22) Filed: May 7, 2025

(30) Foreign Application Priority Data
Feb. 24, 2025 (CN) 2025102020578
Feb. 24, 2025 (CN) 2025202939906

(51) Int. Cl. E05F 11/16; E05F 11/34

(52) U.S. Cl. CPC E05F 11/16; E05F 11/34; E05Y 2900/148

(57) ABSTRACT

The present invention provides an outward-opening mechanism for a window and a window. The window comprises a window frame and an outward-opening window sash, the outward-opening mechanism comprising: a power supply assembly, a power transmission assembly, an execution arm mechanism, and a locking mechanism, wherein the power transmission assembly is configured to, when driven by the power supply assembly, first drive the locking mechanism from a locked state to an unlocked state and then drive the execution arm mechanism from a closed position to an open position. In the above solution, the unlocking and the opening of the window can be achieved by a “one-step” operation by driving the power supply assembly, and the operation is simple.

### FIELD

The present invention relates to the field of outward-opening windows, and specifically to an outward-opening mechanism for a window and a window comprising the same.

### BACKGROUND

In application of outward-opening windows, implementation of a safe and reliable locking mechanism and a convenient opening manner are critical considerations in designing products. A conventional outward-opening window is usually equipped with a mechanical system to not only ensure that the window can be tightly locked to guarantee safety and resistance against wind and water, but also help a user to open the window conveniently for a ventilation purpose. Such windows are generally equipped with two major operable members: the first operable member is a window lever handle which is on a lateral side and connectable with a plurality of internal or external locking pins; the user needs to first pull this handle to release the locking pins to thereby unlock the window; the second operable member is a hand-cranked arm mounted at the bottom of the window; once the locking pins are successfully opened, the user may enable the window to be opened outwardly smoothly by rotating the arm.

However, such outward-opening windows often require a two-step operation: first unlocking with a handle followed by hand-cranked opening, resulting in a relatively cumbersome operational process.

Therefore, the prior art is to be further improved.

### SUMMARY

An object of the present invention is to overcome the aforementioned technical drawbacks by providing an outward-opening mechanism for a window, so as to solve the technical problem existing in the prior art where an outward-opening window requires a two-step operation of first unlocking followed by hand-cranked opening, resulting in operational complexity.

In order to achieve the above technical object, the present invention employs the following technical solutions. In a first aspect, one or more embodiments of an outward-opening mechanism for a window includes:
a power supply assembly disposed on a side of the window frame;
a power transmission assembly connected with the power supply assembly in a transmission way to transmit the power supplied by the power supply assembly, wherein the power transmission assembly comprises a lead screw and a movable block threadedly connected to the lead screw, the lead screw being associated with the power supply assembly and configured to be driven by the power supply assembly to rotate;
an execution arm mechanism with one end being rotatably connected to the movable block and the other end being rotatably connected to the outward-opening window sash, the execution arm mechanism configured to be movable between a closed position and an open position, the outward-opening window sash being closed relative to the window frame when the execution arm mechanism is in the closed position and the outward-opening window sash being open relative to the window frame when the execution arm mechanism is in the open position;
a locking mechanism associated with the power transmission assembly and having a locked state and an unlocked state, wherein the locking mechanism is configured to lock the outward-opening window sash onto the window frame when in the locked state and unlock the outward-opening window sash from the window frame when in the unlocked state,
wherein the power transmission assembly is configured to, when driven by the power supply assembly, first drive the locking mechanism to transition from the locked state to the unlocked state and then drive the execution arm mechanism to move from the closed position to the open position.

In one or more embodiments, the power transmission assembly comprises an actuation mechanism connected to the movable block and the locking mechanism, respectively and configured to actuate the locking mechanism to allow the locking mechanism to transition from the locked state to the unlocked state in response to movement of the movable block.

In one or more embodiments, the outward-opening mechanism further comprises a limiting portion for limiting the position of the execution arm mechanism, wherein the limiting portion comprises a limiting plate fixedly mounted in the window frame, and a limiting post disposed on the limiting plate and protruding in a direction perpendicular to a plane where the limiting plate is located;
wherein the execution arm mechanism comprises:
a link arm with one end being rotatably connected to the movable block;
a sliding slot formed through the link arm on a side adjacent to the power transmission assembly, wherein the limiting post is configured to be slidable in the sliding slot.

In one or more embodiments, the execution arm mechanism further comprises:
a first slider rotatably connected to the other end of the link arm and slidably connected to a bottom of the outward-opening window sash.

In one or more embodiments, the sliding slot comprises:
a movement section configured as a linear slot;
a limiting section connected to the movement section, wherein the limiting section is configured as an arcuate slot and is curved relative to the movement section in a direction toward the power transmission assembly,
wherein when the execution arm mechanism is in the closed position, the limiting post is in the movement section and when the execution arm mechanism is in the open position, the limiting post is in the limiting section.

In one or more embodiments, the actuation mechanism comprises:
a sliding bar fixedly connected to the movable block and slidably disposed in the window frame, wherein the sliding bar is configured to move with the movable block synchronously;
an engagement block fixedly connected to one end of the sliding bar away from the movable block;
an engagement post slidably disposed in the outward-opening window sash, wherein the engagement post is configured to engage and move with the engagement block when the execution arm mechanism is in the closed position,
wherein the engagement post is associated with the locking mechanism such that the engagement post actuates the locking mechanism to transition from the locked state to the unlocked state while it is driven to move.

In one or more embodiments, the locking mechanism comprises a locking receptacle disposed on the window frame, and a locking pin disposed on the outward-opening window sash and configured to cooperate with the locking receptacle, wherein the actuation mechanism further comprises a corner part disposed in the outward-opening window sash, wherein one end of the corner part is connected to the locking pin via the transmission strip, and the other end of the corner part is connected to the post via the transmission strip.

In one or more embodiments, the power supply assembly comprises:
a connecting shank;
a connecting shaft disposed at one end of the connecting shank and rotatably connected to the window frame;
a driving bevel gear fixedly sheathed on the connecting shaft and configured to be driven by the connecting shank to rotate,
the power transmission assembly comprises:
a driven bevel gear in meshing transmission with the driving bevel gear, and fixedly connected to one end of the lead screw.

In one or more embodiments, the power supply assembly further comprises a handle pivotally connected to the connecting shank, a receiving cavity being formed on the connecting shank,
wherein the handle has an initial position and a deployed position, and the handle is configured to be received in the receiving cavity so as to be parallel to the connecting shank upon in the initial position, and perpendicular to the connecting shank upon in the deployed position.

In one or more embodiments, the receiving cavity comprises a first cavity and a second cavity connected with each other, and the second cavity has a width greater than that of the first cavity, wherein the handle is configured to be received in the first cavity, and the second cavity is configured to allow for the end of the handle to be gripped to enable the handle to be moved from the initial position to the deployed position.

In one or more embodiments, the power supply assembly further comprises:
a communication slot formed through the connecting shank on a side away from the handle;
an adapter block with one end being rotatably connected to the communication slot, the connecting shaft being fixedly connected to the adapter block.

In one or more embodiments, the power transmission assembly further comprises:
a first connecting block located adjacent to the driven bevel gear and fixed on a side of the window frame, the lead screw being rotatably provided in the first connecting block;
a second connecting block sheathed at an end of the lead screw away from the driven bevel gear and fixed on a side of the window frame, the second connecting block being located on the same side as the first connecting block.

In one or more embodiments, a first sliding groove and a second sliding groove arranged in parallel with the first sliding groove in a thickness direction of the window frame are formed on the window frame, the first sliding groove being closer to the power transmission assembly than the second sliding groove; and/or, a third sliding groove and a fourth sliding groove arranged in parallel with the third sliding groove in a thickness direction of the outward-opening window sash are formed on the outward-opening window sash,
wherein the limiting plate is fixedly mounted in the first sliding groove, the sliding bar is slidably disposed in the first sliding groove, and the engagement post is slidably disposed in the third sliding groove.

In one or more embodiments, the outward-opening mechanism further comprises a cantilever hinge assembly disposed in the second sliding groove, the cantilever hinge assembly comprising:
a fixed plate fixed in the second sliding groove;
a fifth sliding groove disposed on the fixed plate;
a second slider configured to slide in the fifth sliding groove;
a first link with one end being disposed on the fixed plate in a rotatable manner, and the other end being disposed in the fourth sliding groove in a rotatable manner;
a second link with one end being rotatably connected to the second slider, and the other end being rotatably connected in the fourth sliding groove;
a third link with one end being rotatably connected to the fixed plate, and the other end being rotatably connected to a middle part of the second link, wherein the third link is located between the first link and the second link,
wherein the first link, the second link and the third link are folded with each other to overlap the fixed plate when the outward-opening window sash is located in the window frame.

In one or more embodiments, the power supply assembly comprises an electric motor directly connected to the lead screw via a coupling; and/or,
a dust-proof housing is fixedly disposed on a side of the window frame, and is configured to enclose the power transmission assembly.

In a second aspect, one or more embodiments of an outward-opening mechanism for a window includes:
a power supply assembly disposed on the window frame;
a locking mechanism associated with the power supply assembly, the locking mechanism having a locked state and an unlocked state, the locking mechanism being configured to lock the outward-opening window sash on the window frame when in the locked state and unlock the outward-opening window sash from the window frame when in the unlocked state,
an actuation mechanism connected to the power supply assembly and the locking mechanism, respectively, and configured to actuate the locking mechanism in response to power supplied by the power supply assembly to enable the locking mechanism to transition from the locked state to the unlocked state,
wherein the actuation mechanism comprises:
a sliding bar slidably disposed in the window frame and configured to move when the power supply assembly supplies power;
an engagement block fixedly connected to the sliding bar;
an engagement post slidably disposed in the outward-opening window sash, and configured to engage and move with the engagement block and disengage from the engagement block,
wherein the engagement post is associated with the locking mechanism such that the movement of the engagement post can actuate the locking mechanism to transition from the locked state to the unlocked state.

In one or more embodiments, the outward-opening mechanism further comprises a power transmission assembly which is connected with the power supply assembly in a transmission way to transmit the power supplied by the power supply assembly, wherein the power transmission assembly comprises a lead screw and a movable block threadedly connected to the lead screw, the lead screw being associated with the power supply assembly and configured to be driven by the power supply assembly to rotate, the sliding bar being fixedly connected to the movable block.

In one or more embodiments, the outward-opening mechanism further comprises an execution arm mechanism with one end being rotatably connected to the movable block and the other end being rotatably connected to the outward-opening window sash, wherein the execution arm mechanism is configured to be movable between a closed position and an open position, such that the outward-opening window sash is closed relative to the window frame when the execution arm mechanism is in the closed position and the outward-opening window sash is open relative to the window frame when the execution arm mechanism is in the open position;
wherein the power transmission assembly is configured to, when driven by the power supply assembly, first drive the locking mechanism to transition from the locked state to the unlocked state and then drive the execution arm mechanism to move from the closed position to the open position.

In one or more embodiments, the outward-opening mechanism further comprises a limiting portion for limiting the position of the execution arm mechanism, and the limiting portion comprises a limiting plate and a limiting post, wherein the limiting plate is fixedly mounted in the window frame, and the limiting post is disposed on the limiting plate and protrudes from the limiting plate;
wherein the execution arm mechanism comprises:
a link arm with one end being rotatably connected to the movable block;
a sliding slot formed through the link arm and configured to receive the limiting post, the sliding slot comprising:
a movement section extending in a direction parallel to a length direction of the connecting arm;
a limiting section connected with the movement section, wherein the limiting section is configured as an arcuate slot and is curved relative to the movement section in a direction toward the power transmission assembly.

In a third aspect, one or more embodiments of a window described herein includes: a window frame, an outward-opening window sash and the outward-opening mechanism according to the first or second aspect.

### Advantageous Effects

1. The power transmission assembly is driven by the power supply assembly to perform a transmission, such that the locking mechanism could be first to be driven to transition from the locked state to the unlocked state and then the execution arm mechanism could be driven to move from the closed position to the open position so as to achieve the opening of the window. This solution only needs to drive the power supply assembly to achieve the unlocking and the opening of the window in a “one-step” operation, and the operation is simple.
2. By placing the handle in the receiving cavity of the connecting shank, folding the connecting shank with the adapter block, and then rotating the adapter block to ensure the entire connecting shank in close conformity with the dust-proof housing, the power supply assembly is fully enclosed. This configuration prevents external exposure of the power supply assembly, thereby eliminating potential harm to users and achieving a streamlined, aesthetically cohesive appearance.
3. With the second cavity being provided, the user may place a hand into the second cavity conveniently so as to take out the handle and put the handle in the deployed position.

### BRIEF DESCRIPTION OF THE DRAWINGS

FIG. 1 is a schematic view showing an overall structure of a hand-cranked outward-opening mechanism according to an embodiment of the present invention;

FIG. 2 is a schematic view of a power supply assembly and a power transmission assembly of a hand-cranked outward-opening mechanism according to an embodiment of the present invention;

FIG. 3 is a top view of a power supply assembly and a power transmission assembly of a hand-cranked outward-opening mechanism according to an embodiment of the present invention;

FIG. 4 is a top view showing an overall structure of a hand-cranked outward-opening mechanism according to an embodiment of the present invention;

FIG. 5 is an enlarged view of portion A of FIG. 4;

FIG. 6 is a bottom view showing an overall structure of a hand-cranked outward-opening mechanism according to an embodiment of the present invention;

FIG. 7 is a schematic view showing an overall structure of a link arm of a hand-cranked outward-opening mechanism according to an embodiment of the present invention;

FIG. 8 is a schematic view illustrating a state of a hand-cranked outward-opening mechanism when an outward-opening window sash is closed according to an embodiment of the present invention;

FIG. 9 is a schematic view of a cantilever hinge assembly of a hand-cranked outward-opening mechanism according to an embodiment of the present invention;

FIG. 10 is a schematic view of part of a locking structure of a hand-cranked outward-opening mechanism according to an embodiment of the present invention;

FIG. 11 is an enlarged view of portion B of FIG. 10 according to an embodiment of the present invention;

FIG. 12 is a schematic view of a power supply assembly and a power transmission assembly of a hand-cranked outward-opening mechanism according to an embodiment of the present invention, in which an execution arm mechanism is omitted in comparison with FIG. 2.

### DETAILED DESCRIPTION OF EMBODIMENTS

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

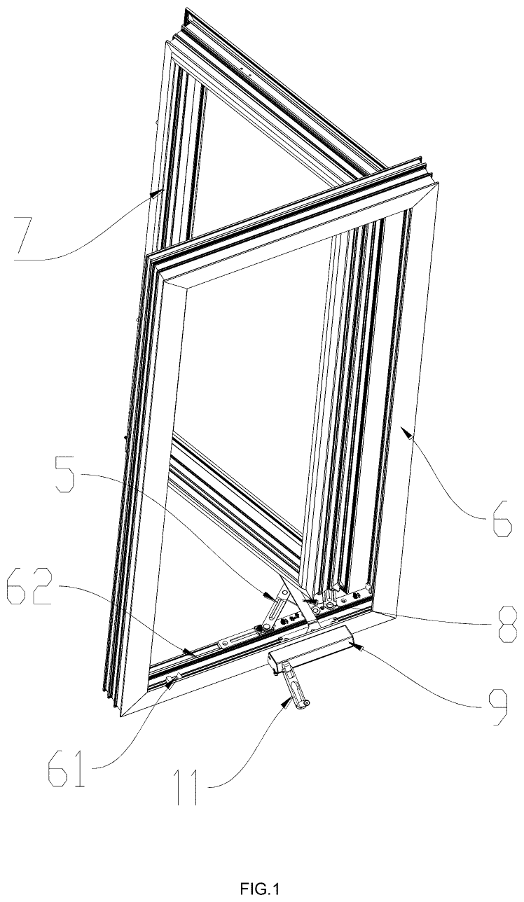

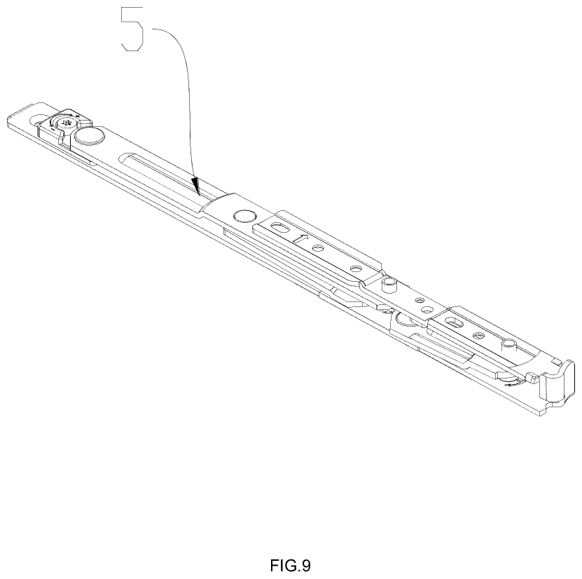

According to an embodiment of the invention, there is provided a hand-cranked outward-opening mechanism for a window. The window comprises a window frame 6 and an outward-opening window sash 7 which is openable and closable with respect to the window frame 6. Referring to FIG. 1 through FIG. 11, the outward-opening mechanism comprises: a power supply assembly 11 provided on a side of the window frame 6; a power transmission assembly 3 configured to transmit the power supplied by the power supply assembly 11 and connect with the power supply assembly 11 in a transmission way; an execution arm mechanism 8 configured to connect the power transmission assembly 3 with the outward-opening window sash 7 and rotatable between a closed position and an open position, wherein when the execution arm mechanism 8 is in the closed position, the outward-opening window sash 7 is closed with respect to the window frame 6, and when the execution arm mechanism 8 is in the open position, the outward-opening window sash 7 is opened with respect to the window frame 6; a locking mechanism associated with the power transmission assembly 3 and having a locked state and an unlocked state, wherein when the locking mechanism is in the locked state, the outward-opening window sash 7 can be locked on the window frame 6, and when the locking mechanism is in the unlocked state, the outward-opening window sash 7 can be unlocked from the window frame 6; an actuation mechanism 4 connected to the power transmission assembly 3 and the locking mechanism, respectively, and configured to actuate the locking mechanism to allow the locking mechanism to transition from the locked state to the unlocked state in response to transmission of the power transmission assembly 3.

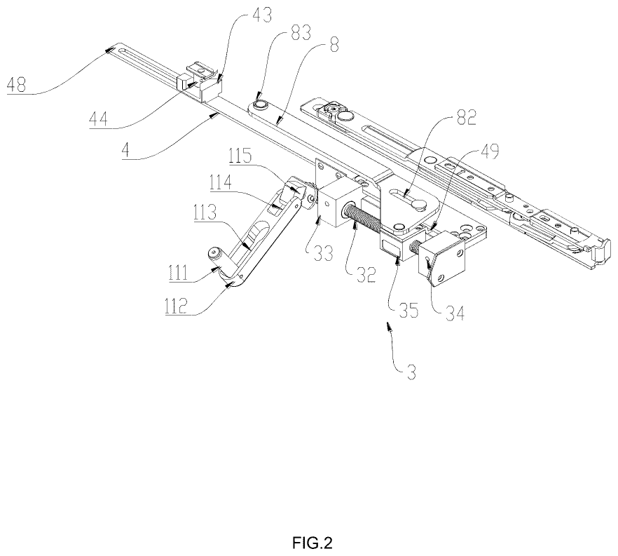

As shown in FIG. 2, the outward-opening mechanism further comprises a limiting portion which is connected to the execution arm mechanism 8 to limit the position of the execution arm mechanism 8. Preferably, the limiting portion is slidably connected to the execution arm mechanism 8. In a preferred embodiment, the limiting portion comprises a limiting plate 41 and a limiting post 42, wherein the limiting plate 41 is fixedly mounted in the window frame 6, and the limiting post 42 is fixedly disposed on the limiting plate 41 and protrudes in a direction perpendicular to a plane where the limiting plate is located.

In operation, the power supply assembly 11 drives the power transmission assembly 3, and in turn drives the actuation mechanism 4 to actuate the locking mechanism so as to allow the locking mechanism to transition from the locked state to the unlocked state to achieve the unlocking of the window, and then the power transmission assembly 3 drives the execution arm mechanism 8 to rotate, such that the outward-opening window sash 7 could be opened by the execution arm mechanism 8 under the constraint of the limiting portion. In this way, the unlocking and the opening of the window can be achieved by a “one-step” operation, and the operation is simple.

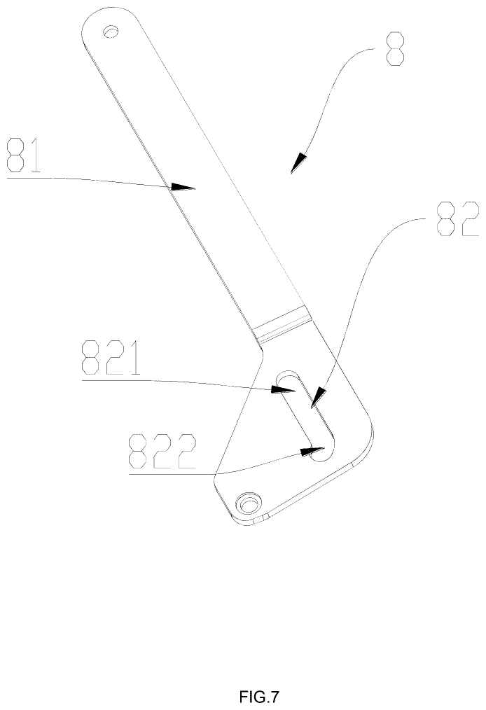

Referring to FIG. 2 and FIG. 7, the execution arm mechanism 8 comprises: a link arm 81 disposed above the limiting plate 41, wherein one end of the link arm 81 is pivotally connected to the power transmission assembly 3; a sliding slot 82 formed through the link arm 81 on a side adjacent to the power transmission assembly 3, the limiting post 42 extending through the sliding slot 82 and being slidable in a movement section 821; a first slider 83 pivotally connected to the other end of the link arm 81 and slidably connected to the bottom of the outward-opening window sash 7.

Referring to FIG. 7, the sliding slot 82 comprises: a movement section 821 configured as a linear slot and extending in a direction coincident with an extension direction of the link arm 81; a limiting section 822 connected to the movement section 821 and disposed at an end of the movement section 821 away from the first slider 83. The limiting section 822 is configured as an arcuate slot and curved relative to the movement section 821 in a direction towards the power transmission assembly 3. When the execution arm mechanism 8 is in a closed position, the limiting post 42 is located in the movement section 821. When the execution arm mechanism 8 is in an open position, the limiting post 42 is located in the limiting section 822.

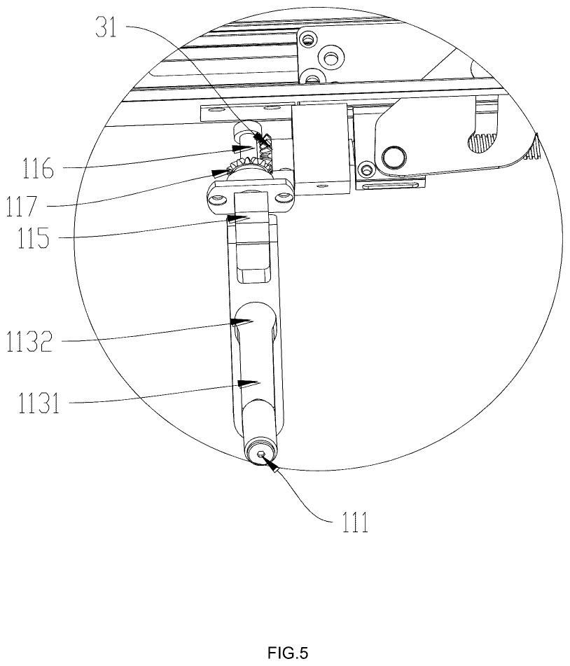

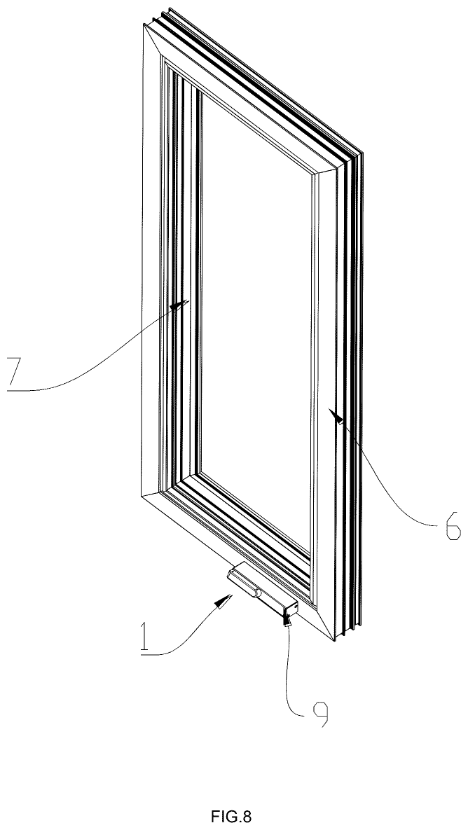

Referring to FIG. 2, FIG. 5 and FIG. 8, the power supply assembly 11 comprises: a handle 111; a connecting shank 112 with one end being rotatably connected with the handle 111 and the other end being rotatably disposed; a receiving cavity 113 disposed on the connecting shank 112 and configured to receive the handle 111, wherein the handle 111 can pivot between an initial position and a deployed position, and wherein the handle 111 is received in the receiving cavity 113 and arranged substantially parallel to the connecting shank 112 when the handle 111 is in the initial position, and the handle 111 is arranged substantially perpendicular to the connecting shank 112 when the handle 111 is in the deployed position; a communication slot 114 formed through the connecting shank 112 on a side away from the handle 111; an adapter block 115 with one end being rotatably connected to the communication slot 114, the adapter block 115 being disposed in the communication slot 114; a connecting shaft 116 fixedly disposed on a side of the adapter block 115 adjacent to the connecting shank 112 and rotatably connected to the window frame 6; a drive bevel gear 117 fixedly sheathed on the connecting shaft 116.

By placing the handle 111 within the receiving cavity 113 of the connecting shank 112, folding the connecting shank 112 with the adapter block 115, and then rotating the adapter block 115 to ensure the entire connecting shank 112 in close conformity with the dust-proof housing 9 as shown in FIG. 8, the power supply assembly 11 is fully enclosed. This configuration prevents external exposure of the power supply assembly 11, thereby eliminating potential harm to users and achieving a streamlined, aesthetically cohesive appearance.

Referring to FIG. 5, the receiving cavity 113 comprises a first cavity 1131 and a second cavity 1132 connected with each other. The width of the second cavity 1132 is larger than that of the first cavity 1131, and the handle 111 can be received in the first cavity 1131. The second cavity 1132 may allow a user to grasp the end of the handle 111 through a large space therein to pivot the handle 111 from the initial position to the deployed position.

Referring to FIG. 2 and FIG. 5, the power transmission assembly 3 further comprises: a driven bevel gear 31 in meshing transmission with a driving bevel gear 117; a lead screw 32 with one end being fixedly connected to the driven bevel gear 31; a first connecting block 33 rotatably sheathed on the lead screw 32, wherein the first connecting block 33 is located at a side adjacent to the driven bevel gear 31 and fixed at a side of the window frame; a second connecting block 34 sheathed at an end of the lead screw 32 away from the driven bevel gear 31, wherein the second connecting block 34 is fixed at a side of the window frame and located at the same side as the first connecting block 33; a movable block 35 threadedly connected with the lead screw 32, the movable block 35 being rotatably connected with the link arm 81. In the depicted illustrative embodiment, the first connecting block 32 and the second connecting block 34 are configured as bearing seats. A planar bearing is mounted in the first connecting block 33, and a deep slot ball bearing is mounted in the second connecting block 34. The first connecting block 32 and the second connecting block 34 are connected with the lead screw 32 via the bearings, respectively.

In use, rotation of the handle 111 drives the rotation of the driving bevel gear 117, thereby transmitting rotational motion to the driven bevel gear 31. This motion subsequently enables the rotation of the lead screw 32, causing the movable block 35 to translate along the lead screw 32, so as to provide mechanical power to the actuation mechanism 4 and the execution arm mechanism 8.

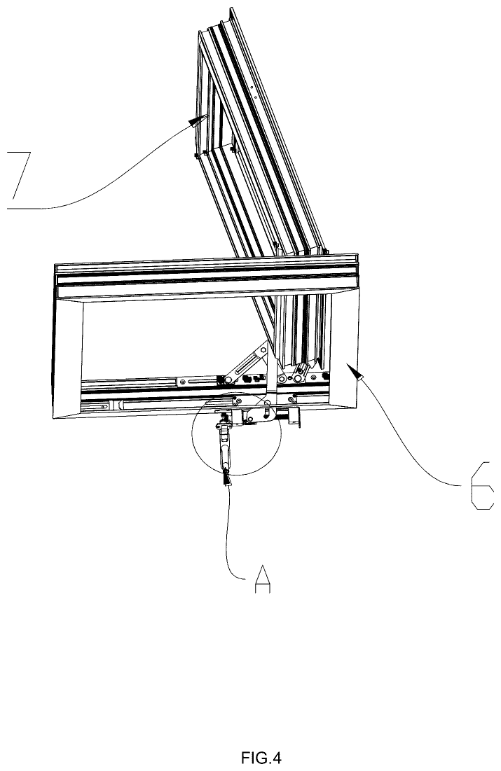

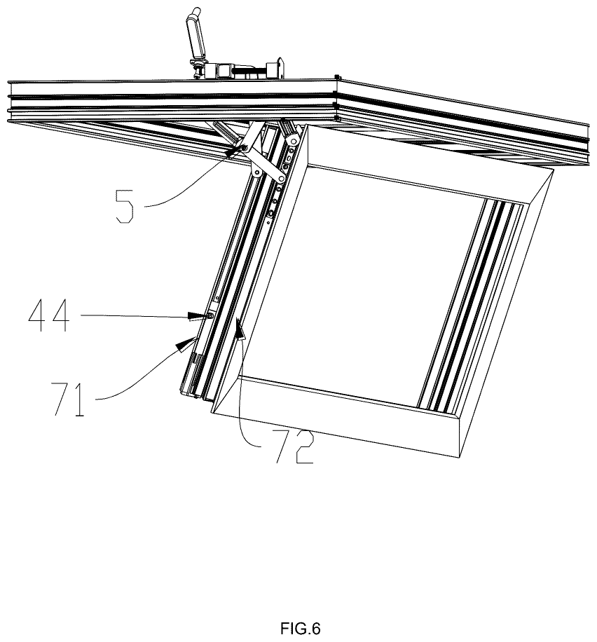

Referring to FIG. 1, FIG. 4 and FIG. 6, a first sliding groove 61 is disposed on one side of the window frame 6 adjacent to the power transmission assembly 3, and a second sliding groove 62 is disposed on other side of the window frame 6 away from the power transmission assembly 3; a third sliding groove 71 is disposed on one side of the outward-opening window 7 adjacent to the power transmission assembly 3, a fourth sliding groove 72 is disposed on other side of the outward-opening window 7 away from the power transmission assembly 3, wherein the first slider 83 is slidably disposed within the third sliding groove 71.

The actuation mechanism 4 and the cantilever hinge assembly 5 are received in the first sliding groove 61 and the second sliding groove 62, respectively, and furthermore, the limiting portion is also disposed in the first sliding groove 61.

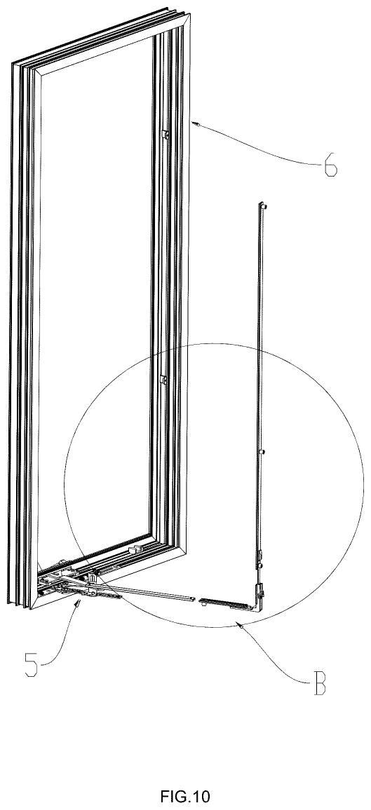

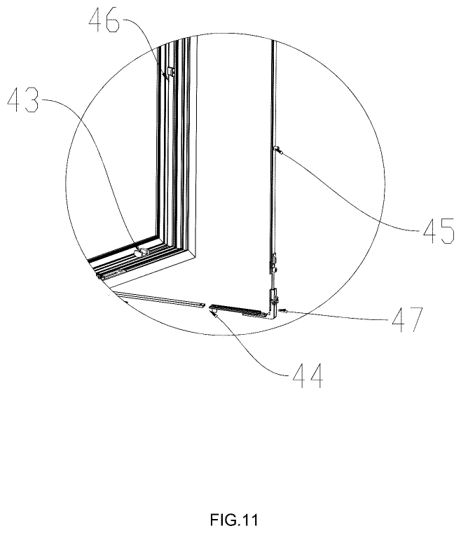

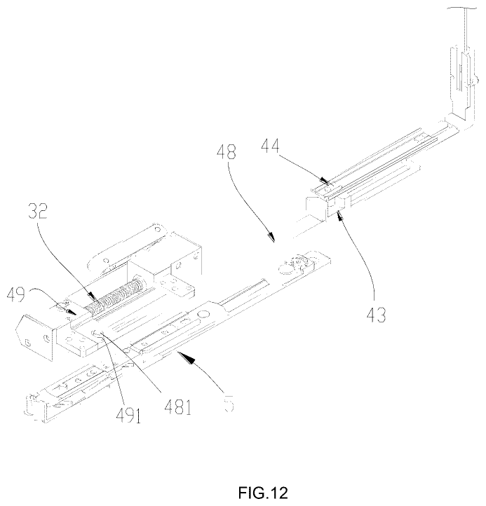

Referring to FIG. 1 through FIG. 3, FIG. 10 and FIG. 11, in the illustrated embodiment, the locking mechanism comprises a locking receptacle 46 disposed on the window frame 6 and a locking pin 45 disposed on the outward-opening window sash 7. The locking pin 45 is slidably provided in the third sliding groove 71, and the locking receptacle 46, which is configured to be snap-fitted with the locking pin 45, is provided in the first sliding groove 61. It will be appreciated that the locking structure shown herein is exemplary only and other locking structures may be selected by those skilled in the art as needed. The actuation mechanism 4 comprises: an engagement block 43 slidably disposed in the first sliding groove 61; an engagement post 44 slidably disposed in the third sliding groove 71; a corner part 47 disposed in the third sliding groove 71, one end of the corner part 47 being connected to the locking pin 45 via a transmission strip, and the other end of the corner part 47 being connected to the engagement post 44 via a transmission strip; a sliding bar 48 slidably disposed in the first sliding groove 61, one end of the sliding bar 48 being fixed to the movable block 35, and the other end of the sliding bar 48 being connected with the engagement block 43. As shown in FIG. 2 and FIG. 12, a positioning post 481 is disposed on a side of the sliding bar 48 adjacent to the movable block 35, and a bent plate 49 with a positioning slot 491 disposed thereon is fixedly connected to the movable block 35. The positioning post 481 is received in the positioning slot 491, so that the positioning post 481 can move together with the bent plate 49 and thus move together with the movable block 35.

Movement of the sliding bar 48 actuates displacement of the engagement block 43, which in turn drives the engagement post 44 to translate. The translation of the engagement post 44 operatively engages the transmission strip mounted on the window frame 6. Simultaneously, the corner part 47 transfers motion to a lateral transmission strip, wherein a locking pin 45 fixed to the transmission strip is driven upward to disengage from a corresponding locking receptacle 46 on the window frame 6, thereby unlocking the window.

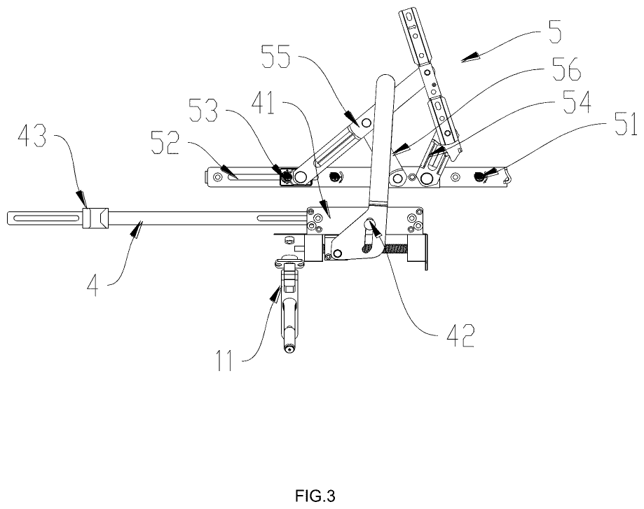

With reference to FIG. 1 and FIG. 3, the outward-opening mechanism further comprises a cantilever hinge assembly 5 disclosed in the second sliding groove 62. The cantilever hinge assembly 5 comprises: a fixed plate 51 fixed in the second sliding groove 62; a fifth sliding groove 52 disposed on the fixed plate 51; a second slider 53 slidable in the fifth sliding groove 52; a first link 54 with one end being disposed on the fixed plate 51 in a rotatable manner, and the other end being provided in the fourth sliding groove 72 in a rotatable manner; a second link 55 with one end being rotatably connected to the second slider 53, and the other end being rotatably connected in the fourth sliding groove 72; a third link 56 located between the first link 54 and the second link 55, one end of the third link 56 being rotatably connected to the fixed plate 51, and the other end of the third link 56 being rotatably connected to the middle part of the second link 55. When the outward-opening window 7 is located in the window frame 6, the first link 54, the second link 55 and the third link 56 are folded with each other to overlap the fixed plate 51.

The opening and closing of the outward-opening window sash 7 relative to the window frame 6 may be achieved by means of the cantilever hinge assembly 5.

In addition to a manual operation, in other preferred embodiments not shown, the power supply assembly 11 may alternatively comprise a motor. The motor is directly connected to the lead screw 32 via a coupling in a transmission manner, thereby replacing the handle 111 and the connecting shank 112 to drive the driving bevel gear 117. A dust-proof housing 9 is fixedly disposed at a side of the window frame 6, enclosing the power transmission assembly 3, the drive bevel gear 117 and the driven bevel gear 31.

The external dust may be isolated by the dust-proof housing 9, preventing the external dust from affecting the lead screw 32 and the movable block 35.

When the power supply assembly 11 is activated, rotation of the lead screw 32 induces linear translation of the movable block 35. The execution arm mechanism 8, constrained by the limiting post 42, moves together with the movable block 35. By configuring the sliding slot 82 of the execution arm mechanism 8 with the linear slot and the arcuate slot, the movement of the execution arm mechanism 8 in the previous stage follows a linear motion, while the movement in the latter stage follows a rotational motion, wherein the intersection of the linear slot and arcuate slot defines a transition point between linear and rotational motions. The first slider 83 may be a roller which, by moving in the fourth sliding groove 72, drives the outward-opening window sash 7 to open or close when the locking pin 45 is unlocked.

When the execution arm mechanism 8 moves linearly with the movable block 35, the sliding bar 48 also moves linearly with the movable block 35 to drive the movement of the engagement block 43 and the engagement post 44 disposed in the engagement block 43, thereby actuating the locking pin 45 of the window to achieve unlocking. When the window is unlocked, the limiting post 42 is just located at the intersection of the linear slot and the arcuate slot. Subsequent rotational movement of the execution arm mechanism 8 releases the engagement post 44 from the engagement block 43, allowing the outward-opening window sash 7 to be opened.

### Operation Workflow (Initial State: FIG. 8)

When the outward-opening window sash 7 is to be opened, the connecting shank 112 is first pivoted to a position perpendicular to the dust-proof housing 9. The handle 111 is then taken out from the receiving cavity 113, transitioning to the configuration shown in FIG. 1. The handle 111 is rotated to drive the driving bevel gear 117 to rotate, which rotates the lead screw 32. The lead screw 32 actuates linear motion of the movable block 35, which concurrently displaces the link arm 81 of the execution arm mechanism 8 and the sliding bar 48 which drives the engagement block 43 and engagement post 44. Translation of the engagement post 44 operatively engages a transmission strip on the window frame 6, while the corner part 47 transfers motion to a lateral transmission strip. The locking pin 45, fixed to the transmission strip, is displaced upward to disengage from the locking receptacle 46, thereby unlocking the outward-opening window sash 7 from the window frame 6. Under the constraint of the limiting post 42 and the driven by the movable block 35, the link arm 81 provides mechanical force to initiate opening of the outward-opening window sash 7. The sash, pivotally connected to the window frame 6 via a cantilever hinge assembly 5, opens through coordinated motion of the components. Such a configuration simplifies the operation by eliminating the need for separate unlocking and manual cranking steps required in conventional systems, thereby enhancing user convenience.

The present invention further provides a window comprising a frame, an outward-opening sash and an outward-opening mechanism. The structure of the outward-opening mechanism has already been described in detail above, and will not be described in detail any more here for the sake of brevity.

It should be appreciated that the terms “first”, “second”, and the like in the description and in the claims of the present application, as well as in the above-described figures, are used for distinguishing similar objects and not necessarily for describing a particular sequential or chronological order. It is to be understood that the data so used is interchangeable under appropriate circumstances such that the embodiments of the present application described herein can be implemented in other sequences than those illustrated or described herein. Furthermore, the terms “comprise” and “have”, as well as any variations thereof, are intended to cover a non-exclusive inclusion, for example, a process, method, system, product, or apparatus that comprises a series of steps or units is not necessarily limited to those steps or units expressly listed, but may include other steps or units not expressly listed or inherent to such process, method, product, or apparatus.

Alternatively, reference may be made to examples described in the above embodiments for specific examples in the present embodiment, and the present embodiment will not be described again here.

In the above embodiments of the present application, the description of each embodiment focuses on different things; parts not described in detail in a certain embodiment can be found from the relevant description of other embodiments.

What are described above are preferred embodiments of the present application. It should be appreciated that those having ordinary skill in the art may further make several improvements and modifications without departing from the spirit of the present application. These improvements and modifications should also be considered as falling within the protection scope of the present application.

### DESCRIPTION OF REFERENCE NUMERALS

11 Power supply assembly; 111 Handle; 112 Connecting shank;
113 Receiving cavity; 1131 First cavity; 1132 Second cavity;
114 Communication slot; 115 Adapter block; 116 Connecting shaft; 117 Driving bevel gear;
3 Power transmission assembly; 31 Driven bevel gear; 32 Lead screw; 33 First connecting block; 34 Second connecting block; 35 Movable block;
4 Actuation mechanism; 41 Limiting plate; 42 Limiting post; 43 Engagement block; 44 Engagement post;
45 Locking pin; 46 Locking receptacle; 47 Corner part; 48 Sliding bar; 49 Bent plate; 481 Positioning post; 491 Positioning slot;
5 Cantilever hinge assembly; 51 Fixed plate; 52 Fifth sliding groove; 53 Second slider; 54 First link; 55 Second link; 56 Third link;
6 Window frame; 61 First sliding groove; 62 Second sliding groove;
7 Outwardly-openable window sash; 71 Third sliding groove; 72 Fourth sliding groove;
8 Execution arm mechanism; 81 Connecting arm; 82 Sliding slot; 821 Movement section; 822 Limiting section; 83 First slider;
9 Dust-proof housing.

1. An outward-opening mechanism for a window, the window comprising a window frame and an outward-opening window sash, wherein the outward-opening mechanism comprises:
a power supply assembly disposed on a side of the window frame;
a power transmission assembly connected with the power supply assembly in a transmission way to transmit the power supplied by the power supply assembly, wherein the power transmission assembly comprises a lead screw and a movable block threadedly connected to the lead screw, the lead screw being associated with the power supply assembly and configured to be driven by the power supply assembly to rotate;
an execution arm mechanism with one end being rotatably connected to the movable block and the other end being rotatably connected to the outward-opening window sash, the execution arm mechanism configured to be movable between a closed position and an open position, the outward-opening window sash being closed relative to the window frame when the execution arm mechanism is in the closed position and the outward-opening window sash being open relative to the window frame when the execution arm mechanism is in the open position; and
a locking mechanism associated with the power transmission assembly and having a locked state and an unlocked state, wherein the locking mechanism is configured to lock the outward-opening window sash onto the window frame when in the locked state and unlock the outward-opening window sash from the window frame when in the unlocked state,
wherein the power transmission assembly is configured to, when driven by the power supply assembly, first drive the locking mechanism to transition from the locked state to the unlocked state and then drive the execution arm mechanism to move from the closed position to the open position.

2. The outward-opening mechanism according to claim 1, wherein the power transmission assembly comprises an actuation mechanism connected to the movable block and the locking mechanism, respectively and configured to actuate the locking mechanism to allow the locking mechanism to transition from the locked state to the unlocked state in response to movement of the movable block.

3. The outward-opening mechanism according to claim 2, wherein the outward-opening mechanism further comprises a limiting portion for limiting the position of the execution arm mechanism, wherein the limiting portion comprises a limiting plate fixedly mounted in the window frame, and a limiting post disposed on the limiting plate and protruding in a direction perpendicular to a plane where the limiting plate is located;
wherein the execution arm mechanism comprises:
a link arm with one end being rotatably connected to the movable block; and
a sliding slot formed through the link arm on a side adjacent to the power transmission assembly, wherein the limiting post is configured to be slidable in the sliding slot.

4. The outward-opening mechanism according to claim 3, wherein the execution arm mechanism further comprises:
a first slider rotatably connected to the other end of the link arm and slidably connected to a bottom of the outward-opening window sash.

5. The outward-opening mechanism according to claim 3, wherein the sliding slot comprises:
a movement section configured as a linear slot; and
a limiting section connected to the movement section, wherein the limiting section is configured as an arcuate slot and is curved relative to the movement section in a direction toward the power transmission assembly,
wherein when the execution arm mechanism is in the closed position, the limiting post is in the movement section and when the execution arm mechanism is in the open position, the limiting post is in the limiting section.

6. The outward-opening mechanism according to claim 3, wherein the actuation mechanism comprises:
a sliding bar fixedly connected to the movable block and slidably disposed in the window frame, wherein the sliding bar is configured to move with the movable block synchronously;
an engagement block fixedly connected to one end of the sliding bar away from the movable block; and
an engagement post slidably disposed in the outward-opening window sash, wherein the engagement post is configured to engage and move with the engagement block when the execution arm mechanism is in the closed position,
wherein the engagement post is associated with the locking mechanism such that the engagement post actuates the locking mechanism to transition from the locked state to the unlocked state while it is driven to move.

7. The outward-opening mechanism according to claim 6, wherein the locking mechanism comprises a locking receptacle disposed on the window frame, and a locking pin disposed on the outward-opening window sash and configured to cooperate with the locking receptacle, wherein the actuation mechanism further comprises a corner part disposed in the outward-opening window sash, wherein one end of the corner part is connected to the locking pin via the transmission strip, and the other end of the corner part is connected to the engagement post via the transmission strip.

8. The outward-opening mechanism according to claim 1, wherein:
the power supply assembly comprises:
a connecting shank;
a connecting shaft disposed at one end of the connecting shank and rotatably connected to the window frame; and
a driving bevel gear fixedly sheathed on the connecting shaft and configured to be driven by the connecting shank to rotate, and
the power transmission assembly comprises:
a driven bevel gear in meshing transmission with the driving bevel gear, and fixedly connected to one end of the lead screw.

9. The outward-opening mechanism according to claim 8, wherein the power supply assembly further comprises a handle pivotally connected to the connecting shank, a receiving cavity being formed on the connecting shank,
wherein the handle has an initial position and a deployed position, and the handle is configured to be received in the receiving cavity so as to be parallel to the connecting shank upon in the initial position, and perpendicular to the connecting shank upon in the deployed position.

10. The outward-opening mechanism according to claim 9, wherein the receiving cavity comprises a first cavity and a second cavity connected with each other, and the second cavity has a width greater than that of the first cavity, wherein the handle is configured to be received in the first cavity, and the second cavity is configured to allow for the end of the handle to be gripped to enable the handle to be moved from the initial position to the deployed position.

11. The outward-opening mechanism according to claim 9, wherein the power supply assembly further comprises:
a communication slot formed through the connecting shank on a side away from the handle; and
an adapter block with one end being rotatably connected to the communication slot, the connecting shaft being fixedly connected to the adapter block.

12. The outward-opening mechanism according to claim 8, wherein the power transmission assembly further comprises:
a first connecting block located adjacent to the driven bevel gear and fixed on a side of the window frame, the lead screw being rotatably provided in the first connecting block; and
a second connecting block sheathed at an end of the lead screw away from the driven bevel gear and fixed on a side of the window frame, the second connecting block being located on the same side as the first connecting block.

13. The outward-opening mechanism according to claim 6, wherein
a first sliding groove and a second sliding groove arranged in parallel with the first sliding groove in a thickness direction of the window frame are formed on the window frame, the first sliding groove being closer to the power transmission assembly than the second sliding groove; and/or,
a third sliding groove and a fourth sliding groove arranged in parallel with the third sliding groove in a thickness direction of the outward-opening window sash are formed on the outward-opening window sash,
wherein the limiting plate is fixedly mounted in the first sliding groove, the sliding bar is slidably disposed in the first sliding groove, and the engagement post is slidably disposed in the third sliding groove.

14. The outward-opening mechanism according to claim 13, further comprising a cantilever hinge assembly disposed in the second sliding groove, the cantilever hinge assembly comprising:
a fixed plate fixed in the second sliding groove;
a fifth sliding groove disposed on the fixed plate;
a second slider configured to slide in the fifth sliding groove;
a first link with one end being disposed on the fixed plate in a rotatable manner, and the other end being disposed in the fourth sliding groove in a rotatable manner;
a second link with one end being rotatably connected to the second slider, and the other end being rotatably connected in the fourth sliding groove; and
a third link with one end being rotatably connected to the fixed plate, and the other end being rotatably connected to a middle part of the second link, wherein the third link is located between the first link and the second link,
wherein the first link, the second link and the third link are folded with each other to overlap the fixed plate when the outward-opening window sash is located in the window frame.

15. The outward-opening mechanism according to claim 5, wherein the power supply assembly comprises an electric motor directly connected to the lead screw via a coupling; and/or,
a dust-proof housing is fixedly disposed on a side of the window frame, and is configured to enclose the power transmission assembly.

16. An outward-opening mechanism for a window, the window comprising a window frame and an outward-opening window sash, wherein the outward-opening mechanism comprises:
a power supply assembly disposed on the window frame;
a locking mechanism associated with the power supply assembly, the locking mechanism having a locked state and an unlocked state, the locking mechanism being configured to lock the outward-opening window sash on the window frame when in the locked state and unlock the outward-opening window sash from the window frame when in the unlocked state, and
an actuation mechanism connected to the power supply assembly and the locking mechanism, respectively, and configured to actuate the locking mechanism in response to power supplied by the power supply assembly to enable the locking mechanism to transition from the locked state to the unlocked state,
wherein the actuation mechanism comprises:
a sliding bar slidably disposed in the window frame and configured to move when the power supply assembly supplies power;
an engagement block fixedly connected to the sliding bar; and
an engagement post slidably disposed in the outward-opening window sash, and configured to engage and move with the engagement block and disengage from the engagement block,
wherein the engagement post is associated with the locking mechanism such that the movement of the engagement post can actuate the locking mechanism to transition from the locked state to the unlocked state.

17. The outward-opening mechanism according to claim 16, wherein the outward-opening mechanism further comprises a power transmission assembly which is connected with the power supply assembly in a transmission way to transmit the power supplied by the power supply assembly, wherein the power transmission assembly comprises a lead screw and a movable block threadedly connected to the lead screw, the lead screw being associated with the power supply assembly and configured to be driven by the power supply assembly to rotate, the sliding bar being fixedly connected to the movable block.

18. The outward-opening mechanism according to claim 17, further comprising an execution arm mechanism with one end being rotatably connected to the movable block and the other end being rotatably connected to the outward-opening window sash, wherein the execution arm mechanism is configured to be movable between a closed position and an open position, such that the outward-opening window sash is closed relative to the window frame when the execution arm mechanism is in the closed position and the outward-opening window sash is open relative to the window frame when the execution arm mechanism is in the open position;
wherein the power transmission assembly is configured to, when driven by the power supply assembly, first drive the locking mechanism to transition from the locked state to the unlocked state and then drive the execution arm mechanism to move from the closed position to the open position.

19. The outward-opening mechanism according to claim 18, wherein the outward-opening mechanism further comprises a limiting portion for limiting the position of the execution arm mechanism, and the limiting portion comprises a limiting plate and a limiting post, wherein the limiting plate is fixedly mounted in the window frame, and the limiting post is disposed on the limiting plate and protrudes from the limiting plate;
wherein the execution arm mechanism comprises:
a link arm with one end being rotatably connected to the movable block; and
a sliding slot formed through the link arm and configured to receive the limiting post, the sliding slot comprising:
a movement section extending in a direction parallel to a length direction of the connecting arm; and
a limiting section connected with the movement section, wherein the limiting section is configured as an arcuate slot and is curved relative to the movement section in a direction toward the power transmission assembly.

20. A window, comprising a window frame, an outward-opening window sash and the outward-opening mechanism according to claim 1.
